(19) United States
(12) Patent Application Publication
(10) Pub. No.: US 2008/0110323 A1
(43) Pub. Date: May 15, 2008

(54) Interactive composition palette

(75) Inventors: C. Daniel Bergfeld, New Canaan, CT (US); Karen Nisenson, New Canaan, CT (US)

Correspondence Address: ST. ONGE STEWARD JOHNSTON & REENS, LLC, 986 BEDFORD STREET, STAMFORD, CT, 06905-5619, US

(73) Assignee: LearninGrove, LLC, New Canaan, CT (US)

(21) Appl. No.: 11/595,247

(22) Filed: Nov. 10, 2006

(51) Int. Cl. G01P 3/00

(52) U.S. Cl. 84/626

(57) ABSTRACT

A system for providing an audio and visual music composition including a composition server accessible to at least one user via a communications network, at least one instrument database accessible by the server including a plurality of musical instruments, a user interface generated by software executing on the server, the user interface including a backdrop and an instrument palette for selecting at least one of the musical instruments, software executing on the server for receiving at least one curve on the backdrop from the user, the curve indicative of at least one frequency of the musical instrument, and a player for outputting a dynamic audio and visual representation of the at least one curve.

### FIELD OF THE INVENTION

The invention relates to music visualization, and more specifically to a system and method for providing an interactive composition palette for creating visual and auditory stimuli.

### BACKGROUND OF THE INVENTION

Various techniques and programs for music visualization are known. For example, music visualization features are often found in media player software and generate animated imagery based on a piece of recorded music. The imagery is generated by the software and synchronized with the music as it is played. The changes in the music's volume and frequency spectrum are among the properties used as input to the visualization. Visualization techniques range from a simple simulation of an oscilloscope display to displays including a plurality of composite effects.

Some musical visualization software allows users to customize what is displayed. For example, U.S. Pat. No. 6,395,969 discloses a method for storing visual effects, such as images or video clips, and selecting one of the visual effects to integrate with music. The visual effect and music are then played together. While the selected visual effect and music may be played in synchronization, the method of the '969 patent does not provide any means to create music from a visual image, or create a visual image from music.

It is therefore desired to provide a system and method for creating music from a visual image, and vice versa.

### SUMMARY OF THE INVENTION

According, it is an object of the present invention to provide a creative means to bring together visual and audio stimuli.

It is a further object of the present invention to provide a system and method for developing sensory integration.

It is a further object of the present invention to provide a system and method for providing visual and auditory musical composition.

These and other objectives are achieved by providing a system for creating and/or providing an audio and visual music composition, including a composition server accessible to at least one user via a communications network, at least one instrument database accessible by the server including a plurality of musical instruments, a user interface generated by software executing on the server, the user interface including a backdrop and an instrument palette for selecting at least one of the musical instruments, software executing on the server for receiving at least one curve on the backdrop from the user, the curve indicative of at least one frequency of the musical instrument, and a player for outputting a dynamic audio and visual representation of the at least one curve.

In some embodiments, the system further includes at least one color database accessible by the server including a plurality of colors, wherein the user interface further includes a color palette for selecting at least one of the colors for the at least one curve.

Further provided is a system for creating and/or providing an audio and visual music composition, including at least one processor, at least one instrument database accessible by the processor including a plurality of musical instruments, at least one color database accessible by the at least one processor including a plurality of colors, software executing on the at least one processor for generating a user interface, the user interface including a backdrop, an instrument palette for selecting at least one of the musical instruments, software executing on the at least one processor for receiving at least one curve on the backdrop from the user, the curve indicative of at least one frequency of the musical instrument, and software executing on the at least one processor for outputting a dynamic audio and visual representation of the backdrop, wherein the user interface further includes a color palette for selecting at least one of the colors for the at least one curve.

Also provided is a method for creating and/or providing an audio and visual music composition, including the steps of selecting at least one musical instrument from a instrument database via a graphical user interface, selecting at least one color from a color database via the graphical user interface, providing at least one curve on a backdrop of the graphical user interface, the at least one curve indicative of at least two frequencies of the musical instrument and the at least one color, and outputting a dynamic audio and visual representation of the at least one curve. The method may further include a step of selecting a brush for providing the at least one curve, e.g., wherein the step of selecting the brush includes selecting a brush width, the brush width indicative of one of a pitch, a duration and a volume.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is system for providing an audio and visual music composition according to an exemplary embodiment of the present invention.

FIG. 2 is user interface of the system shown in FIG. 1.

FIG. 3 is another user interface of the system shown in FIG. 1.

FIG. 4 illustrates a method for providing an audio and visual music composition employable by the system shown in FIG. 1.

### DETAILED DESCRIPTION OF THE INVENTION

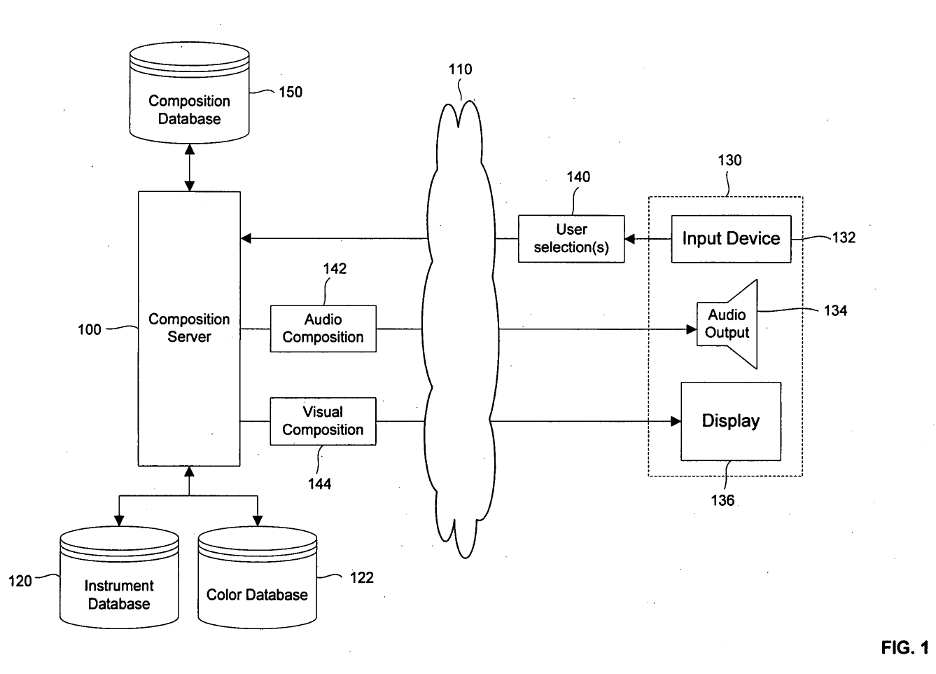

FIG. 1 shows a system for creating and/or providing an audio and visual composition according to an exemplary embodiment of the present invention. The system includes at least one composition server 100 accessible to users via a communications network 110. The server 100 includes one or more processors for executing software thereon. The communication network 110 may be, for example, a local area network (“LAN”), a wireless local area network (“WLAN”), an intranet, and/or the Internet.

The system further includes one or more databases, such as an instrument database 120 and at least one color database 122. The databases may be collocated with the server 100, or remote thereto and accessible via the network 110. The databases may also be stored on portable media device (e.g., CD, DVD, etc.) or locally to a personal computer. The instrument database 120 includes data indicative of a plurality of musical instruments. The colors database includes data indicative of a plurality of colors. The system further includes one or more composition databases 150 including audio and visual compositions generated by the system or users thereof.

Users of the system (e.g., children or adults) may provide input or user selections 140 to the composition server 100 via any device 130 such as a personal computer (e.g., desktop, laptop, tablet, etc.) or handheld electronic device (e.g., PDA, Internet accessible mobile phone, etc). The device 130 includes an input device 132, such as a keyboard, mouse, touch screen interface and/or tablet input panel. In one exemplary embodiment, the input device 132 is or includes a keyboard and/or synthesizer. The device 130 further includes an audio output 134 and display 136.

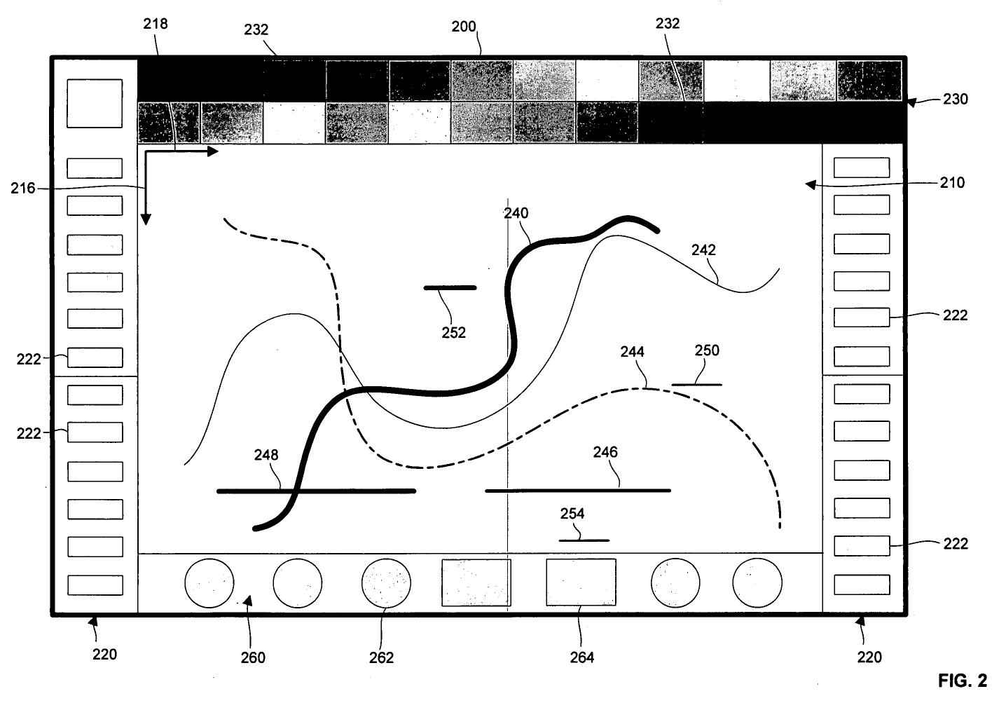

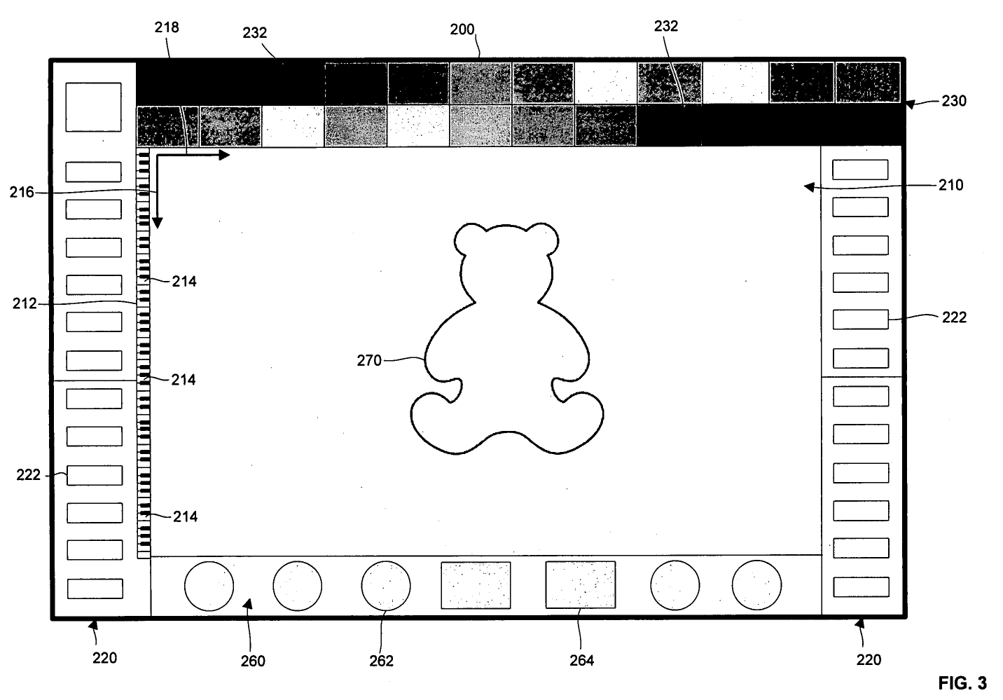

The system includes software for generating a user interface 200. Software of the system may be stored on the server 100, on a portable media device, or on the device 130. Likewise, the software may be executed on the composition server 100 and/or a device 130. Exemplary embodiments of the user interface generated by the system are shown in FIGS. 2 and 3. As shown in FIG. 2, the user interface 200 includes a backdrop 210 having one or more axis's 216/218.

In one exemplary embodiment, the vertical axis 216 corresponds to frequency and the horizontal axis 218 corresponds to time. The frequency or frequencies along the axis 216 correspond to frequencies of musical instruments. For example, each of the frequencies may correspond to a Musical Instrument Digital Interface (“MIDI”) note number. As shown in FIG. 3, a keyboard 212 having any number of keys 214 (e.g., corresponding to MIDI note numbers) may be represented on the user interface 200 if desired.

The user interface also includes any number of instrument palettes 220 for selecting at least one musical instrument (e.g., from the database 120). The instrument palettes 220 may include any number instrument selectors 222 indicative of instruments, and instrument types or sections (e.g., strings, brass, woodwinds, percussions, etc.). The user interface 200 may also include a color palette 230 for selecting at least one color 232 (e.g., from the database 122). In some embodiments, a musical instrument may correspond to a particular color. For example, the system or a user thereof may predefine a color/instrument match permanently, or temporarily for a particular composition session.

The user interface further includes a curve selector and/or brush (e.g., paint brush) selector. The curve and brush selectors may be located anywhere on the user interface 200, such as in the panel 260 (e.g., selector 262). The panel 260 may include any number of selectors, e.g., for curves, brushes, composition playing and storing, song selection, help, and/or system preferences. Selectors may also be embodied in one or more drop-down menus. Selectors allow a user to choose a paint brush type and size, and/or a curve width or style for creating a curve on the backdrop 210.

The system further includes software for receiving the curves on the backdrop 210 from the user. For example, a user may create a curve (and/or line) using the input device 132 (e.g., mouse, touch screen, etc.) of the device 130. FIG. 2 shows several exemplary curves 240-254 created by the system and/or users thereof. Each of the curves 240-254 is indicative of at least one frequency or note of a selected musical instrument, or a plurality of frequencies (e.g., at each point along the curve). Each curve corresponds to a particular musical instrument and may be of a selected color and selected curve width or style. Characteristics of each curve (e.g., width, pattern, style, etc.) may be indicative of pitch, duration, volume, or any other musical characteristic.

The system also includes player (e.g., software) for outputting a dynamic audio and visual representation of the at least one curve (e.g., operable via a selector 264). The player provides audio composition data 142 and visual composition data 144 to the user. In one exemplary embodiment, playing a composition includes automating and/or scrolling the backdrop 210 (e.g., along the time axis) and interpreting an instrument and frequency and each point along each of the curves 240-254. Playing further includes the system interpreting any number of other characteristics present on the backdrop including pitch, duration, volume, etc. Music indicative of the curves represented on the backdrop 210 is then provided to the user together with the scrolling or otherwise automated visual composition.

A user may play his/her composition while creating a composition (i.e., in real time) or upon completion of the composition. Users may therefore create a visual composition and hear what it sounds like. The visual portion of the composition may be a collection of curves as shown in FIG. 2, one or more shapes, or a drawing and/or painting. Users may also play any number of stored compositions, e.g., in the composition database 150. The stored compositions may include those created by the particular user, by other users, or automatically by the system.

Users may also listen to music corresponding stored shapes, designs, compositions, and visual art. For example, as shown in FIG. 3, a user may play the image 270 and hear music that corresponds to each of the curves comprised in the image 270. It is contemplated that users may customize predefined images to select instruments and curve characteristics that correspond to portions of the images. Users may further add additional curves to the image 270. A user may also select an image and use the mouse to trace the lines of the image while the system generates a sound pattern based on a preset sound pattern protocol.

The system according to the present invention may also generate a visual composition based on music. For example, a user may select a song (e.g., a classic children's tune or a familiar classical music theme) via the user interface 200. The system then generates a visual pattern on the backdrop that visually animates the selected music based on a preset visual pattern protocol.

Compositions may be saved and stored locally on each user's computer, or on the composition server 100. In some embodiments, at least some of the compositions stored on the server 100 are accessible via an Internet webpage. For example, a website of the system may include a gallery of user created compositions for others to enjoy (e.g., view, play, purchase, download, rate, etc).

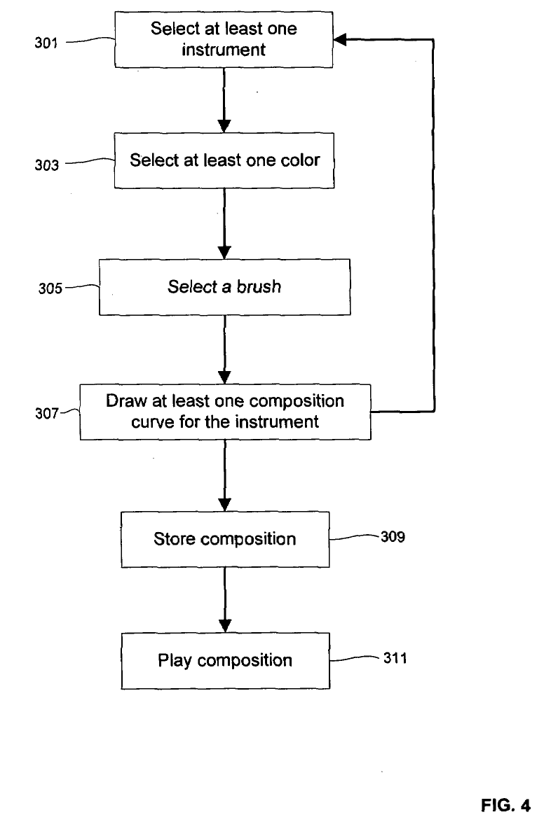

FIG. 4 shows a method for creating and/or providing an audio and visual music composition employable by the system shown in FIG. 1. It should be noted that, while various functions and methods have been described and presented in a sequence of steps, the sequence has been provided merely as an illustration of one advantageous embodiment, and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

The method includes a first step of selecting at least one musical instrument, e.g., from an instrument database (step 301). The instrument may be selected from the instrument pallet 220 via the user interface 200 of the system. Next, at least one color is selected, e.g., from a color database (step 303). A user may also select a brush (step 305) and any number of brush characteristics such as a brush width.

One or more curves (e.g., corresponding to the selected instrument and/or color) may be drawn on the user interface using the brush (step 307). A user may select any number of instruments, colors and brushes to create a visual composition via the user interface. The user may then store the composition, locally and/or remotely (step 309). The composition may be played to output a dynamic audio and visual representation of the at least one curve (step 311).

Advantages of the present invention include the provision of a system and method that brings together visual and auditory stimuli, and allows users to create and play visual and auditory compositions. The system also advantageously provides a means of integrating auditory and visual neuropaths to expand sensory experience and learning capabilities.

Although the invention has been described with reference to a particular arrangement of parts, features and the like, these are not intended to exhaust all possible arrangements or features, and indeed many modifications and variations will be ascertainable to those of skill in the art.

What is claimed is:

1. A system for providing an audio and visual music composition, comprising:
a composition server accessible to at least one user via a communications network;
at least one instrument database accessible by said server including a plurality of musical instruments;
a user interface generated by software executing on said server, said user interface including a backdrop and an instrument palette for selecting at least one of the musical instruments;
software executing on said server for receiving at least one curve on the backdrop from the user, the curve indicative of at least one frequency of the musical instrument; and
a player for outputting a dynamic audio and visual representation of the at least one curve.

2. The system according to claim 1, further comprising:
at least one color database accessible by said server including a plurality of colors,
wherein said user interface further includes a color palette for selecting at least one of the colors for the at least one curve.

3. The system according to claim 1, wherein said user interface further comprises a curve selector for selecting a width of the at least one curve, wherein the width is indicative of one of a pitch, a duration, and a volume.

4. The system according to claim 1, wherein said user interface further includes at least one brush selector for selecting a brush type for providing the at least one curve.

5. The system according to claim 1, wherein the backdrop includes a vertical axis and a horizontal axis, wherein the vertical axis corresponds to frequency and the horizontal axis corresponds to time.

6. The system according to claim 1, wherein the each of the at least one frequencies correspond to a MIDI note number.

7. The system according to claim 1, wherein said software for receiving at least one curve receives a plurality of curves corresponding to two or more musical instruments.

8. The system according to claim 1, wherein the user interface is displayable on a handheld device.

9. The system according to claim 1, further comprising:
a touch screen display for displaying the user interface and receiving the at least one curve.

10. The system according to claim 1, further comprising:
at least one composition database accessible to said server comprising a plurality of audio and visual compositions executable by said player.

11. The system according to claim 1, wherein the instrument palette includes two or more instrument sections, the two or more sections including at least one of strings, brass, woodwinds, and percussions.

12. The system according to claim 1, wherein the curve is received from an input device, the input device including at least one of a computer keyboard, a MIDI keyboard, a mouse, and a touch screen.

13. A system for providing an audio and visual music composition, comprising:
at least one processor;
at least one instrument database accessible by said processor including a plurality of musical instruments;
at least one color database accessible by said at least one processor including a plurality of colors;
software executing on said at least one processor for generating a user interface, the user interface including a backdrop, an instrument palette for selecting at least one of the musical instruments;
software executing on said at least one processor for receiving at least one curve on the backdrop from the user, the curve indicative of at least one frequency of the musical instrument; and
software executing on said at least one processor for outputting a dynamic audio and visual representation of the backdrop,
wherein said user interface further includes a color palette for selecting at least one of the colors for the at least one curve.

14. The system according to claim 13, wherein said software for receiving the at least one curve further receives at least one line.

15. The system according to claim 13, wherein said processor is a handheld device processor.

16. The system according to claim 13, further comprising a touch screen display, wherein said software for receiving said at least one curve receives the at least one curve via the touch screen display.

17. The system according to claim 13, wherein the at least one curve is received from an input device, the input device including at least one of a computer keyboard, a MIDI keyboard, a mouse, and a touch screen.

18. A method for providing an audio and visual music composition, comprising the steps of:
selecting at least one musical instrument from a instrument database via a graphical user interface;
selecting at least one color from a color database via the graphical user interface;
providing at least one curve on a backdrop of the graphical user interface, the at least one curve indicative of at least two frequencies of the musical instrument and the at least one color; and
outputting a dynamic audio and visual representation of the at least one curve.

19. The method according to claim 18, further comprising the step of:
selecting a brush for providing the at least one curve.

20. The method according to claim 19, wherein said step of selecting the brush includes selecting a brush width, the brush width indicative of one of a pitch, a duration and a volume.

21. The method according to claim 18, further comprising the step of:
storing the dynamic audio and visual representation.

22. The method according to claim 18, further comprising the step of:
providing at least one line indicative of at least one frequency on the backdrop, wherein the dynamic audio and visual representation includes the at least one line.
